(19) United States
(12) Patent Application Publication
(10) Pub. No.: US 2008/0266699 A1
(43) Pub. Date: Oct. 30, 2008

(54) WRITE RETRY METHOD AND MAGNETIC TAPE APPARATUS

(76) Inventors: Setsuko Masuda, Yokahama City (JP); Kenji Nakamura, Sagamihara (JP); Yutaka Oishi, Kawasaki-shi (JP)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 12/107,308

(22) Filed: Apr. 22, 2008

(30) Foreign Application Priority Data
Apr. 27, 2007 (JP) 2007-120301

(51) Int. Cl. G11B 15/18

(52) U.S. Cl. 360/69

(57) ABSTRACT

The present invention provides: a write retry method which reduces the number of permanent errors; and a magnetic tape apparatus in which the method is implemented. In a write control method of the present invention, at least one dataset is written into a space of a predetermined distance in a lengthwise direction of a tape medium. A write ERP of the present invention can reduce occurrence of permanent errors before time-out, thereby having an advantageous effect of reducing the number of unnecessary requests for exchange of tape cartridges.

### FIELD OF THE INVENTION

The present invention relates to a retry method for a recovery procedure for a write error (an error recovery procedure) of a magnetic tape apparatus (hereinafter, referred to also as a tape drive). Specifically, the present invention relates to: an improved retry method for a recovery procedure of a write error; and a magnetic tape apparatus in which the method is implemented.

### BACKGROUND OF THE INVENTION

Tape drives conforming to LTO (Linear Tape Open) have been developed. Into these tape drives conforming to LTO, data is written by unit called a dataset (hereinafter, referred to also as DS). In accordance with the standards, a space for each dataset (a distance from the terminal of a certain dataset to the terminal of a dataset subsequent thereto) must be within the specified limit of a certain distance (the 4-meter rule).

Additionally, large-sized independent tape drive products (IBM3592 and the like) for enterprise use have been developed. These tape drives are also designed to write data to a tape so that a space for each dataset must be within the specified limit of a certain distance (the 4-meter rule).

FIG. 1 is a block diagram that shows a configuration of a general data apparatus system. A write operation for a dataset by a tape drive will be described. Here, an outline is provided for a flow in which the tape drive writes plural pieces of data into a recording medium (a tape) by unit of a dataset, the plural pieces sent from a higher-level apparatus (for example, a host) 105 and having arbitrary sizes. A dataset is a collection of plural pieces of data, and is a unit by which data is written into a tape having a format structure of a fixed length.

A tape drive 100 includes an interface 110, a buffer 120, a read-write channel 130, a tape 14a, a head 14b, reels 14c and 14d, a cartridge 14e, a motor 150, a controller 160, a head position control system 170 and a motor driver 185. The interface 110 communicates with the host 105. The tape drive 100 receives, from the host 105 through the interface 110, commands for instructing the tape drive 100 to write data into the buffer 120 and the tape 14a. In a case where a standard for communication of the interface 110 is SCSI, the commands are Write commands and Write FileMarks commands. The buffer 120 is a memory, for example, a DRAM, which stores data that should be written into the tape 14a.

The tape 14a is a magnetic tape medium in which data is recorded. Data transmitted through the read-write channel 130 is written into the tape 14a by the head 14b by unit of a dataset, for example, 400 kilobytes. The tape 14a is wound around the reels 14c and 14d, and, with rotation of these reels, moves in a lengthwise direction of the tape 14a, that is, in a direction from the reel 14c to of reel 14d, or in a direction opposite thereto. The motor 150 rotates the reels 14c and 14d, thereby moving the tape against the write head 14b. A steady-state speed at the time of writing into/reading from the tape is, for example, 6.22 to 2.5 m/s. The controller 160 controls the entire tape drive 100. The controller 160 also controls writing of data into the tape 14a, the head position control system 170, and the motor driver 185.

FIG. 2 shows that datasets (DS) are written into a tape at intervals each of which is made as short as possible in order to increase a recording density. Usually, an interval between each two adjacent datasets is made as short as possible in order to increase a recording density.

When there is a scratch, dust or the like on the tape, it is difficult to continuously write datasets into a problematic part of the recording medium while minimizing each dataset interval for the purpose of giving priority to a data recording density. The controller 160 also includes data write/read control means. In a case where an error occurs while a dataset is being written into the tape, the controller controls a rewrite (a retry) in accordance with an error recovery procedure (ERP).

In a conventional ERP method for a tape drive, a rewrite (a retry) is performed with a tape forward only by a small distance. An object thereof is to provide a technique for improving a write performance by reducing a write ERP time. Accordingly, the conventional tape drive does not cover a technique for avoiding occurrence of a permanent error to the extent as possible.

In addition to the technique mentioned above, there are a number of techniques of the ERP for the time of writing. Two typical examples will be shown.

In a method disclosed in Japanese Patent Application Publication No. PUPA08-45200, when a write error is detected, a retry operation is performed n times. If the write error cannot be eliminated, a dummy block is written after a tape is run forward by a given length (the fifth embodiment of the invention). If the error is found at a write position in the first half of the tape, a head is advanced forward by a considerably long distance (a given length), and a write of the dummy data is tried. Then, when the write of the dummy data ends in failure, it is judged that there is a large scratch on the tape, and then, abnormal termination is executed by judging this case as a medium failure. On the other hand, when the write of the dummy data succeeds, a write is tried again after returning to an original write position (in the first half) by judging that the write is highly likely to succeed in the original position. An object of Japanese Patent Application Publication No. PUPA08-45200 is reducing a time period from issue of a write command to abnormal termination, even though a probability of abnormal termination (a permanent error) is increased.

In Japanese Patent Publication No. 3436206, described is a method with which a rewrite (a retry) of a physical block is performed for a data error in a position forward of the tape during a write operation of the physical block. When the retry is performed, the physical block is divided into parts at the point when the data error is detected, whereby the amount of data (the divided physical block) that should be written by a retry operation is minimized. Japanese Patent Publication No. 3436206 discloses a retry method capable of reducing a retry time period for a data error because the amount of data that should be written at the time of a retry is reduced.

A main object of each of the ERP methods described in these patent documents is also to improve a write performance of a tape drive even if there are a defect in a tape medium, and existence of instability of hardware in the drive. In this method, a permanent error is promptly reported for the purpose of giving priority to a write performance. However, such focus on the write performance may possibly be overkill for minor defects of the tape cartridge and of the tape drive.

In some cases, it is desired to avoid a case where a write error is carelessly judged and handled as a permanent error in an operational perspective of a tape library system, because finally returning a permanent error in response to a write command requires an exchange of tape cartridges.

As has been described above, in the conventional retry, only a retry is repeated after a small distance movement for avoiding a local write error, and a write performance is improved only to a small extent by promptly judging whether or not an error is a permanent one. Additionally, a writing operation in which a data error is promptly judged as a permanent error in a certain region through retires does not take advantages of the 4-meter rule that “a space for each dataset must be within 4 meters”.

### SUMMARY OF THE INVENTION

In view of the above mentioned problems, the present invention relates to providing: a write retry method for reducing permanent errors; and a magnetic tape apparatus in which the method is implemented.

One aspect of the present invention is a write control method by which at least one dataset is written over a course of a predetermined distance in a lengthwise direction of a tape medium. This write control method comprises: repeating a retry operation of writing a dataset at a tape position reached by forwarding the tape medium only by a small distance from a tape position where the dataset has been tried to be written, when an error occurs during the writing of the dataset; and executing a retry operation after forwarding the tape medium by a distance slightly short of the predetermined distance to reach a forward tape position from a tape position of the last dataset properly written, in a case of occurrence of any one of events, in the repeating step, where the retry operation is repeated a predetermined number of times, and where a write time limit for one dataset expires.

Additionally, an aspect of the write control method of the present invention is that the predetermined number of times of repeating the retry operation is 5 to 15; and the time limit is a value being 10 to 15 minutes (with respect to a write time-out of 16 minutes).

In addition, another aspect of the write control method of the present invention is that the predetermined distance is 4 meters.

Moreover, yet another aspect of the write control method of the present invention is that a combination of small distances in the repeated retry operations includes any one of 0, 17 and 23 LPOS (1 LPOS=7.2 mm)

Furthermore, yet another aspect of the write control method of the present invention is that the forward tape position is a tape position reached by forwarding the tape medium from the tape position of the last dataset properly written by a distance obtained by subtracting 17 or 23 LOPS from the predetermined distance.

Still furthermore, yet another aspect of the write control method of the present invention is that the forward tape position is a forward position reached by movement of a certain distance from a write tape position of the last retried dataset, the certain distance not requiring a backhitch to be performed.

Furthermore, another aspect of the present invention is a magnetic tape apparatus for writing at least one dataset into a space of a predetermined distance in a lengthwise direction of a tape medium. The magnetic tape apparatus comprises write control means which: repeats a retry operation of writing a dataset at a tape position reached by forwarding the tape medium only by a small distance from a tape position where the dataset has been tried to be written, when an error occurs during the writing of the dataset; and executes a retry operation after forwarding the tape medium by a distance slightly short of the predetermined distance to reach a forward tape position from a tape position of the last dataset properly written, in a case of occurrence of any one of events, in the repeating step, where the retry operation is repeated a predetermined number of times, and where a write time limit for one dataset expires.

According to the present invention, a write ERP of a tape drive can reduce cases including an occurrence of permanent error within a time-out as compared to the conventional write ERPs, and thus has an advantageous effect of reducing unnecessary requests for exchanging tape cartridges.

### BRIEF DESCRIPTION OF THE DRAWINGS

For a more complete understanding of the present invention and the advantage thereof, reference is now made to the following description taken in conjunction with the accompanying drawings.

FIG. 1 is a block diagram of a general tape drive.

FIG. 2 shows that data is written into a tape in which, in order to increase a recording density, an interval between each two adjacent datasets (DS) is made as short as possible.

FIG. 3 shows a typical dataset write ERP.

FIG. 4 shows an ERP of one embodiment of the present invention.

FIG. 5 is a flowchart showing specific steps of the ERP of the embodiment.

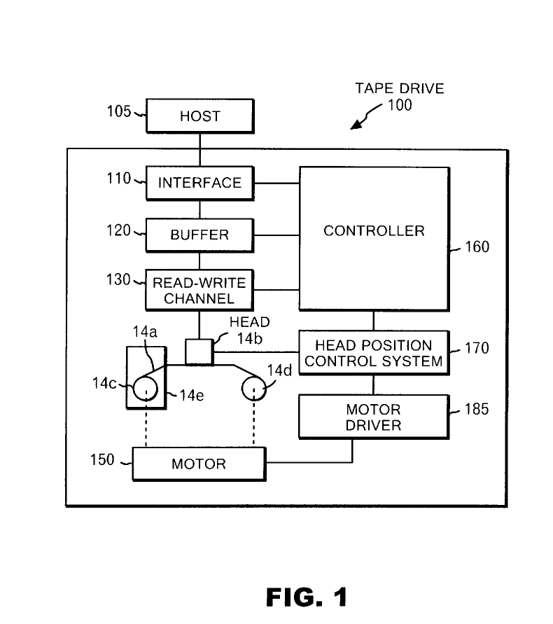

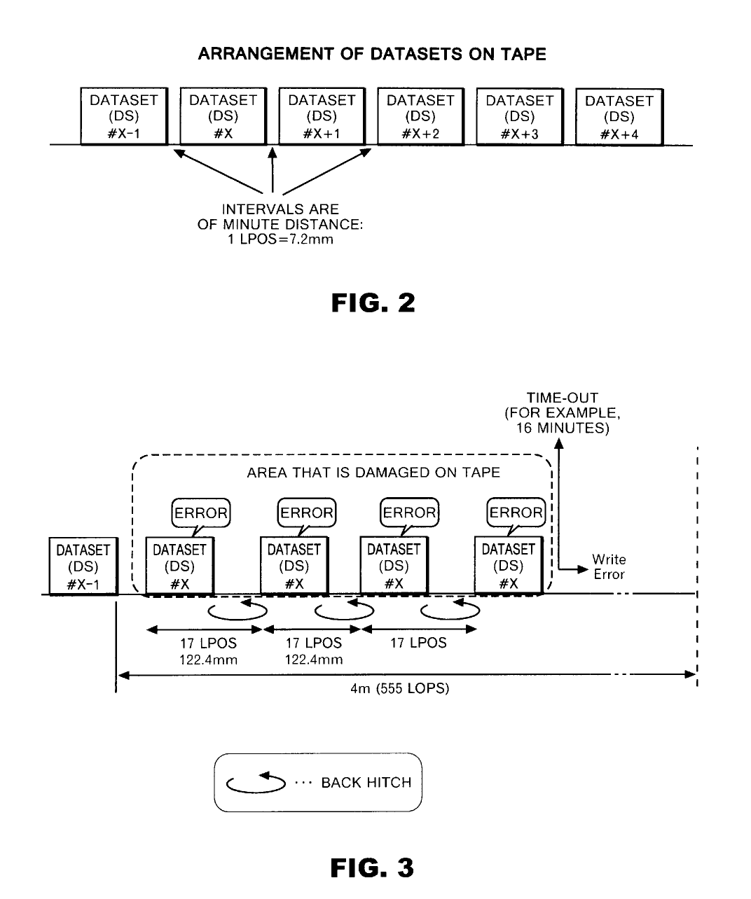

### DETAILED DESCRIPTION OF THE INVENTION

By referring to the accompanying drawings, embodiments of the present invention will be described below in detail. However, the embodiments do not limit the invention according to the scope of claims.

Methods for determining a write position at the time of rewriting a dataset are changed between the first half and the latter half of a procedure (ERP: error recovery procedure). The method employed in the first half is the same as a conventional retry method. A position obtained by adding, to a tape position where a write error of a dataset has occurred, a constant determined by the error (whether it is a servo error or a data flow error) is utilized as a new write tape position. In a retry in the latter half (the last one retry or each of the last several retries), writing is tried after forwarding a tape by nearly 4 meters from a position of a dataset having been properly written most recently. In other words, a position having a certain distance from a tape position of the dataset having been properly written most recently is utilized as a tape position for a retry in the latter half, the certain distance being obtained by subtracting a predetermined value from 4 meters. This implementation is an ERP operation which occurs only after a retry has already been repeated many times.

The ERP method in the first half will be described. When a difficult position, such as a defective part, is encountered during writing into a tape drive, a retry operation is performed by typical steps of an error recovery procedure (ERP). When an error occurs during writing of a dataset, a write tape position for the dataset is forwarded by a small distance (10 to 25 LPOS) in a direction in which the tape progresses. LPOS is a unit of a length in a lengthwise direction used for a tape, and 1 LOPS (Longitudinal Position) is equivalent to 7.2 mm. A distance between datasets, which is 4 meters, is about 555 LPOS. In the ERP implemented in a tape drive, when a servo error has occurred, a tape is forwarded only by a small distance of 17 LPOS. When a data flow error in which, immediately after data has been written, the data cannot be read out, the tape is forwarded only by a small distance of 23 LPOS from a tape position into which writing has been performed most recently.

When a retry occurs frequently during the writing of a dataset subsequent to a certain dataset having been properly written most recently, a tape position for the retry moves in a direction in which the tape position spreads out from a tape position into which the certain dataset has been written. Here, the small distances are sizes of not more than 5% of a predetermined distance restriction (the 4-meter rule). Accordingly, in the present description, a retry after movement of a distance of not more than 5% of a length of the 4-meter rule is called a retry with a “small distance” movement. Even if this retry with a small distance movement is repeated ten times, it is only a half of the 4-meter rule that can be reached at most.

Because a tape drive is required to satisfy a write performance, the tape drive is not allowed to continue performing a retry beyond a time limit (a time-out: 16 to 18 minutes) for writing of one dataset. When a retry is not completed within the time limit, the tape drive informs a host that the writing of the dataset has resulted in a permanent error, and a system and a person who uses the system deal with the error by exchanging tape cartridges. Additionally, an operation in which, without moving a write position, a retry is repeated in the same tape position as a position where a write error has occurred may be included.

Next, descriptions will be provided for a case where a backhitch operation is performed between each two consecutive retry operations each with a small distance movement. In order to write datasets into a tape medium so that a subsequent dataset can be written in a position immediately after the last dataset written into the tape medium, the following operations of the tape and a motor driver are performed, which are:

(1) Reducing a running speed of the tape medium to temporarily stop the tape medium; and then,

(2) Performing a write motor operation in which the subsequent data is written after moving the tape medium backward in the reverse direction (returning the tape medium excessively backward beyond a write position, and then accelerating the tape medium in the forward direction), and then causing the tape medium to move at a write speed in a position into which this data should be written.

A series of operations of (1) and (2) is called a backhitch, and requires two to three seconds. Reduction of a data recording density is evaded by having a retry of one dataset executed without leaving a large distance for the retry position as shown in FIG. 3 by causing a backhitch operation to exist between each two consecutive retry operations.

The performing of the backhitch operation during retry operations causes a retry of one dataset to be executed in a position not leaving a large distance from the last retry position, and this prevents a data recording density from reducing.

FIG. 3 shows a typical dataset write ERP. It shows that a tape drive is executing a retry of a dataset (DS) #X in a defect area of a tape.

The backhitch can occur at the time of each retry of the ERP. It shows that a backhitch operation exists at a tape position obtained by forwarding the tape by a small distance. Two to three seconds are spent for each retry because, every time a retry is performed, a backhitch must be performed so that the head 14b can be positioned at a tape position obtained by forwarding the tape by a small distance.

On the other hand, a write time limit (a time-out) is set for every write command. It is necessary to terminate writing of one dataset so that a time taken for the writing can be within a certain time period (for example, 16 minutes). In order not to cause the time-out, implementation of repeating a rewrite until a write tape position reaches the distance limit of 4 meters is performed. In the first half of the implemented ERP, forward movements of the write position are repeated by a small distance a predetermined number of times (for example, 8 to 13 times) in order to avoid a cause of an error, such as a defect, locally existing in a specific area. After having repeated a retry until the write tape position reaches an area which is around 2 meters away from a tape position into which data has been properly written most recently, a write control means 160 of the tape drive returns a permanent error because the time-out has been reached then. As a result, the tape drive comes to request exchange of tape cartridges.

Thus, a tape position at which steps of the ERP in which the time-out is taken into consideration is at most around 2 meters away from the tape position into which a dataset has been properly written most recently. In the ERP in the first half, a retry is repeated by a small distance in an area within 2 meters from the tape position into which a dataset has been properly written most recently. A retry (in the first half) with a small distance movement is significant in that it leads to avoidance of a defect locally existing. Additionally, a design philosophy for a retry (in the first half) whose movement is limited to a small distance movement is that using an entirety of a recording area within the distance limit from the beginning is significant in evading reduction of a recording density when a lot of write errors has occurred in a tape cartridge.

Additionally, during each of the retry operations by small distances in a forwarding direction, a maximum speed that is stable in terms of data error rate with respect to a write channel is selected out of steady speeds of the tape at the time of writing, which are between 6.22 and 2.5 m/S. By thus configuring the retry operations, a backhitch operation taking two to three seconds exists in every retry operation in order that a head is positioned at a tape position forward of an error position by the small distance. Consequently, a number of retry times is restricted within a given time-out period.

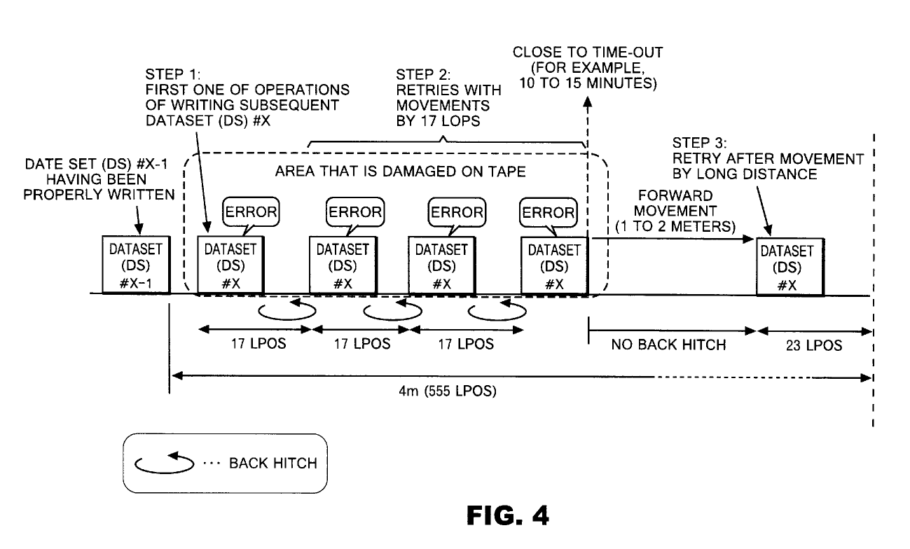

FIG. 4 shows a specific example of one method of a procedure (an ERP) for recovering from a DS write error. This embodiment example repeats a retrial (a retry) after an error has occurred during the writing of a dataset. It shows a method by which a starting point for determining a write position of the last retrial is changed, from a tape position into which a dataset has been properly written most recently, to a position being 4 meters away therefrom, which is the largest interval between adjacent two datasets. Positions from which the writing of the retry operation into a tape is started are determined as follows.

1: The first write position=a terminal of a dataset having been properly written most recently+forwarding of the tape by 1 LPOS.

2: This is a part of the retry in the first half having been already explained.

A write position of a retrial after occurrence of an error in a damaged area of the tape in which a defect locally exists=a write position when an error has occurred most recently+forwarding of the tape by 17 or 23 LPOS. A backhitch taking two to three seconds exists in every one of these retries.

3: This is the retry part in the latter half.

A write position of a retry in the latter half=a terminal of a dataset having been properly written most recently+forwarding of the tape by a distance which is 4 meters minus 17 or 23 LPOS. This retry is positioned on the tape forward of the terminal by a long distance (about one to two meters) that does not allow a backhitch to occur. This long distance movement is a movement from a tape position of a DS #X−1 by a distance slightly short of a limit value of the 4-meter rule, or a movement by about one to two meters from a tape position corresponding to a DS #X for which the last retry is performed in the step 2. By this long distance movement in a direction in which the tape progresses, even a defect which makes writing impossible in the step 2 can be avoided.

The ERP of this embodiment example is characterized in that, in the step 3, a retry is performed after the tape is moved, from a tape position of a DS having been properly written, by a distance slightly short of the 4-meter restriction. A time period taken for entirely repeating a retry in the step 2 becomes close to a time-out (a time limit of the first half is 10 to 15 minutes in relation to a time-out period of 16 minutes) when a write position of the retry has reached around 2 meters from the tape position of the DS #X−1 having been properly written most recently. A forward movement of the retry in the step 3 by a long distance is a forward movement by one to two meters at a stretch from the tape position of the last retry in the step 2. This long distance (relative to “a small distance”) is a distance allowing the tape to be moved without requiring a backhitch with a constant speed for moving the tape forward. Accordingly, a backhitch operation taking two to three seconds irrelevant to the write operation is not necessitated. Note that, after the retry operation with the long-distance movement in the step 3, a retry operation with a forward movement by a small distance may be repeated on the premise that a condition of being within the write time-out and a condition of the 4-meter rule are satisfied.

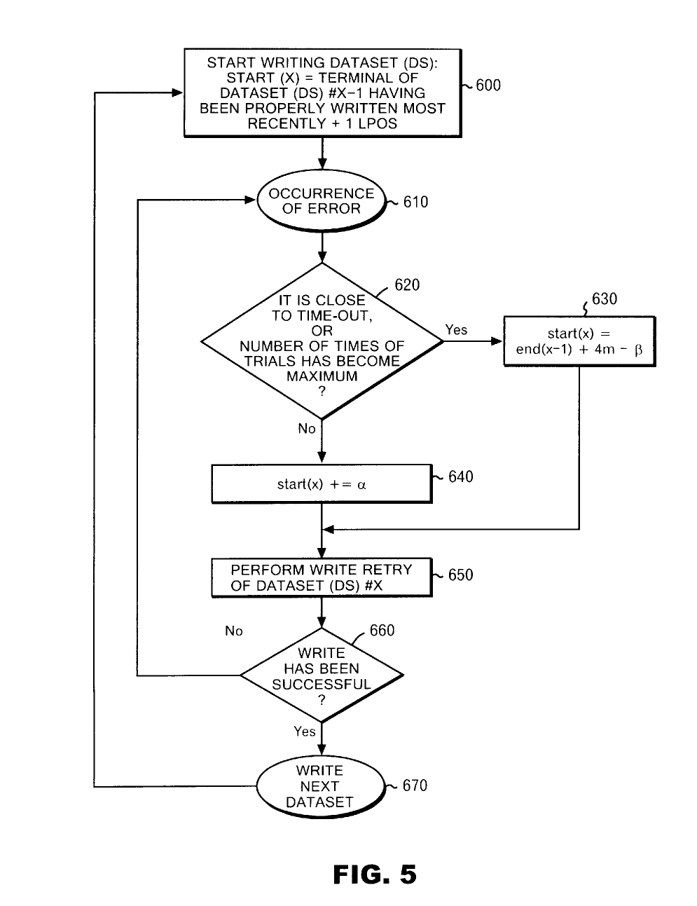

FIG. 5 shows a flowchart for carrying out the steps 1 to 3 of the ERP of the embodiment. A procedure (the steps 1 to 3) for determining a write position can be expressed by the following flow chart. In FIG. 5, “start (x)” is a write position of the dataset (DS) #X, and “end (x)” is a position at which the writing of the dataset #X ends. “α” and “β” are uniquely determined in accordance with the kind of an error having occurred. In the current implementation, “α” is 17 LPOS in the case of an servo error, and is 23 LPOS in the case of a data flow error. “α” may be 0 LPOS, and this value means that a retry is repeated at the same write tape position.

### —Step 1—

A value obtained by adding 1 LPOS to a terminal position of the dataset (DS) #X−1 having been correctly written most recently is set as the smallest value of start (x). In order not to decrease a recording density, the tape drive writes data after reducing a distance between each two adjacent datasets.

### —Step 2—

It is assumed that writing of the dataset #X−1 is performed, for example, in a defect area of the tape. A write retry of the dataset (DS) #X−1 in this area results in an error. In order to avoid this error area, a retry is executed after a write position is moved forward by setting α=17 LPOS (122.4 mm) or 23 LPOS (165.6 mm). However, in the case of a defect spreading out 2 meters forward of a position of the data having been properly written most recently, if only repetition of a retry with a movement by a small distance of less than 2 centimeters is performed, a time-out period is consumed, and it finally leads to a permanent error.

### —Step 3—

In 610, errors for earlier writes (670 and 600), and for retries subsequent thereto are judged. In execution of a retry (630) in the latter half, it is judged whether any one of conditions that the retry has become close to a write time-out, and that a number of retry times has reached a maximum value, has been satisfied (620). For example, when a retry with a small-distance movement in the step 2 is close (10 to 15 minutes) to a time-out (for example, 16 minutes), a retry in the step 3 is executed relatively early so as to avoid a permanent error (630 and 650). In 630, instead of making a small distance movement having been made so far, a write tape position is positioned at a position away, from a tape position end (# X−1) of the dataset (DS) #X−1 having been properly written most recently, by a distance which is β short of the 4-meter distance limit. In the step 3, a permanent error by the time-out can be evaded by selecting, for a last retry, an area different from a plurality of retry areas in the step 2. As the retry in the latter half in the step 3, a retry in 630 may be executed when the number of times of retries in the first half in the step 2 has reached a maximum number of times (for example, 13).

Hereinabove, a write control method for a tape in a sequential apparatus, such as the tape drive of the embodiment of the present invention, has been disclosed. By the retry in the step 3, before the tape drive reports a host about an error, it is made possible without fail to try the writing of a dataset by using an area in the neighborhood of a position obtained with a maximum value (the 4-meter rule) for an interval between each adjacent two datasets which is permitted by specifications of the tape drive. Thereby, a dataset can be written by leaping a scratch on a tape which cannot be leaped in the conventional methods. In a tape drive and a tape library system, a necessary option to be selected for writing an enormous amount of data is to cause a data write system not to request exchange of tape cartridges, but to continuously write data, even when a tape medium has defects in a minute area.

Additionally, in a retry with a movement slightly short of the limit value of the 4-meter rule, the backhitch does not exist because the retry involves a forward movement of the long-distance (one to two meters). Hence, the ERP of the present invention has an advantageous effect of enabling decision on a permanent error (tape cartridge exchange) to be made until it becomes immediately before the time-out. Note that, in an entirety (400 meters) of the tape, a retry location utilizing the 4-meter restriction up to the limit thereof does not occur so many times, it is considered that the ERP of the present invention does not bring about large reduction of a recording density as an entirety of a tape cartridge.

It is apparent to those skilled in the art that various modifications or improvements can be added to the abovementioned embodiment. Obviously, embodiments to which such modifications or improvements have been added are also included in the technical scope of the present invention.

Although the preferred embodiment of the present invention has been described in detail, it should be understood that various changes, substitutions and alternations can be made therein without departing from spirit and scope of the inventions as defined by the appended claims.

What is claimed is:

1. A write control method for writing at least one dataset in a space of a predetermined distance in a lengthwise direction of a tape medium, the method comprising:
repeating a retry operation of writing a dataset at a tape position reached by forwarding the tape medium only by a small distance from a tape position where the dataset has been tried to be written, when an error occurs during the writing of the dataset; and
executing a retry operation after forwarding the tape medium by a distance slightly short of the predetermined distance to reach a forward tape position from a tape position of the last dataset properly written, in a case of occurrence of any one of events, in the repeating step, where the retry operation is repeated a predetermined number of times, and where a write time limit for one dataset expires.

2. The method according to claim 1, wherein the forward tape position is a forward position reached by movement of a certain distance from a write tape position of the last retried dataset, the certain distance not requiring a backhitch to be performed.

3. The method according to claim 2, wherein the predetermined distance is 4 meters.

4. The method according to claim 1, wherein a combination of small distances in the repeated retry operations includes any one of 0, 17 and 23 longitudinal position (LPOS)

5. The method according to claim 4, wherein the forward tape position is a tape position reached by forwarding the tape medium from the tape position of the last dataset properly written by a distance obtained by subtracting 17 or 23 LOPS from the predetermined distance.

6. A magnetic tape apparatus for writing at least one dataset into a space of a predetermined distance in a lengthwise direction of a tape medium, the magnetic tape apparatus comprising:
write control means which: repeats a retry operation of writing a dataset at a tape position reached by forwarding the tape medium only by a small distance from a tape position where the dataset has been tried to be written, when an error occurs during the writing of the dataset; and executes a retry operation after forwarding the tape medium by a distance slightly short of the predetermined distance to reach a forward tape position from a tape position of the last dataset properly written, in a case of occurrence of any one of events, in the repeating step, where the retry operation is repeated a predetermined number of times, and where a write time limit for one dataset expires.
